(19) United States
(12) Patent Application Publication
(10) Pub. No.: US 2012/0227227 A1
(43) Pub. Date: Sep. 13, 2012

(54) URNS IN THE SHAPE OF SPORTS ARTICLES

(75) Inventor: Ralf Heckenbach, Corpus Christi, TX (US)

(73) Assignee: BAVARIAN INVESTMENT GROUP, LLC, Corpus Christi, TX (US)

(21) Appl. No.: 13/479,375

(22) Filed: May 24, 2012

Related U.S. Application Data
(63) Continuation of application No. 12/456,170, filed on Jun. 12, 2009, now Pat. No. 8,196,274.

(51) Int. Cl. A61G 17/08

(52) U.S. Cl. 27/1

(57) ABSTRACT

Disclosed is a single unit crematory urn in the shape of a sports article within which cremated remains of humans or pets are disposed. The article can be, for example, in the shape of a basketball, football, baseball, baseball bat, baseball glove, hockey puck, hockey stick, a helmet and the like. The urn has a substantially planar surface for securing to a flat surface. A base may optionally be utilized to secure the bottom of the article and retain it in an upright position. The article is a replica constructed out of substantially rigid polymeric material. The article may optionally be covered with a clear case to protect from the environment. The single unit has an opening, and removable closure, to allow the cremated remains to be placed within. The unit may be constructed with partition(s) for holding the cremated remains of more than one human or pet.

### CLAIM FOR PRIORITY

This application is a continuation of U.S. patent application Ser. No. 12/456,170 of the same title, filed Jun. 12, 2009, now U.S. Pat. No. ______. The priority of U.S. patent application Ser. No. 12/456,170 is hereby claimed and its disclosure incorporated herein by reference.

### FIELD OF THE INVENTION

The present invention relates generally to funeral products, and more particularly, to cremation containers in the shape of sports articles, for memorializing one whose cremated remains are contained therein.

### BACKGROUND OF THE INVENTION

Cremation of the mortal remains of living creatures, such as humans and pets, has become increasingly popular. The popularity of cremation is due to the fact that it is less expensive than being interred into the ground and it may avoid storage charges if the remains are located within the individual's residence if not stored at some exterior location, such as in a mortuary. The end product of the cremation process, after removal of non-combustible materials and grinding, is a small volume of finely ground ash.

Disposal of this ash has taken many forms. One form would be to dispose of the ash into a sea, ocean, lake, or on land in a particular location. In such an instance, there is no need for a burial urn. However, some people choose to retain some or all of the cremated remains as constituting a memory of the loved one that has been lost.

Upon the death of a loved one, human or pet, it is often desired to memorialize the deceased's life in some personal manner. Even where the deceased ashes are scattered, it is often desired to retain and display the scattering container, for example, on a fireplace mantel, coffee table, end table or the like, as a means for memorializing a loved one.

Cremation urns are well known and have been described for instance in U.S. Pat. No. 2,009,724, dated Jul. 30, 1935, as invented by Bircher, directed to a receptacle comprising 2 parts having abutting edges, the edges being grooved to receive a sealing strip.

Today, there remains a demand for more styles and designs of cremation containers. One popular design theme for cremation urns is the outdoor or animal theme, considering that one of the most common places for scattering ashes is the backyard or garden. In this regard, there have been proposed various attractive means for displaying cremation containers.

Typically, burial urns take the form of a vase, box, birdhouse, or a similar type of container where the cremated remains of the loved one are to be placed.

For example, U.S. Pat. No. 5,029,373 to Raymond discloses a cremation container in the form of a flower vase. The container has a first compartment for storing the ashes of a deceased and a separate second compartment for holding and displaying flowers.

U.S. Pat. No. 6,175,995 to Parker et al. and U.S. Pat. No. D444,933 to Parker show various cremation containers in the forms of lawn and garden ornaments. Specifically, these patents show decorative structures such as sun dials, planters, wind chimes and bird baths that all have an inner compartment for maintaining and securing the ashes of a deceased in a permanent manner. U.S. Pat. No. 7,272,874 discloses birdhouses to be used as cremation urns. U.S. Pat. No. 6,763,558 discloses vehicle shaped caskets and urns. However, for the sports enthusiasts, a cremation container in the form of a sports article from a favorite sport is desirable.

Heiso Corporation in Germany has been selling metal steel urns, one of which is in the shape of a soccer ball. No other sports shaped articles are displayed. The steel is heavy, subject to corrosion and ill effects of the elements, and relatively expensive, at least compared to lighter weight plastic as an alternative material. In addition, the ball shaped urn article is separate from the base provided.

In The Light Urns is a cremation urn company selling sports shaped urns online where an actual sports article is utilized and displayed under a clear case. Ashes or cremated remains are stored in a separate wooden base.

It has been heretofore unknown to provide a cremation container in the form of a sports article such as a basketball, baseball, or related items (e.g., bat, glove, etc), hockey puck, football, or the like which is constructed in a cost effective manner, from long lasting lightweight material, and wherein the cremated remains are stored in the sports article itself. Accordingly, it would be desirable to provide an alternative means of memorializing a loved one with a history as a sports enthusiast to what has previously been available.

### SUMMARY OF THE INVENTION

In summary, the present invention discloses sports shaped articles for use as urns to hold the cremated remains of human or pet loved ones. The urns of the present invention are stylized funeral containers that are configured to reflect the particular choice of the deceased's favorite sport. The sports shaped articles or funeral containers include a body portion and a lid or open portion, all as one piece. The ashes are held in the sports shaped article or body portion. An opening with a lid, or optionally a removable closure, can be placed in the sports shaped article for inserting the cremated remains. Optionally, a mounting base portion may be positioned underneath the sports shaped article to provide support for the article itself.

The single-unit urns of the present invention have a substantially planar surface for securing to or laying flush against a flat surface. The urns are suitably formed from a non-metal material.

Optionally, an interior body retaining compartment is located inside of the sports shaped article. As a further feature, the interior may have separate compartments, and be filled through two access openings each opening to a discrete individual compartment. This is so that remains of two individuals may be kept in one urn. Separate compartments in the interior allow for the remains of the separate individuals to not be disturbed when the remains of a second individual are added to the urn.

If desired, the article can be covered with a clear or colored case to protect the article and cremated remains therein. The cover case can be attached to the base or it may just lie on top of the base, covering the sports shaped article. If attached thereto, the cover case may pivot openly about a plurality of hinges that connect the case to the base.

Another feature of the present invention is to have a faceplate on the base or the cover case identifying the deceased. Another related feature is to display a sports emblem from, for example, a favorite sports team of the deceased. The identification members contain features that are particular to the deceased and their interests.

Accordingly, it is a principal object of the invention to provide urns that are designed to reflect sports oriented culture and interest of the deceased.

It is another object of the invention to provide urns that feature the lines, curves and recognizable styling of specific sports articles.

Further embodiments and features will be apparent from the description which follows.

### BRIEF DESCRIPTION OF THE DRAWINGS

The invention is described in detail below with reference to the appended drawings, wherein like numerals designate similar parts. In the Figures:

FIG. 1 is a view of a crematory urn in the shape of a basketball on a base;

FIG. 2 is a partial view of the basketball positioned on a narrower type of base;

FIG. 3 is a view of the back of the basketball and base unit wherein the aperture is placed on the back of the unit, and is shown having a lockable, hinge-type closure;

FIG. 4 is a view of a baseball bat on a representative base;

FIG. 5 is a sectional view of the basketball and base unit of FIG. 3, showing a partition within the basketball and the base;

FIG. 6 is a sectional view of the basketball and base unit of FIG. 3, presenting an alternative embodiment to FIG. 5, in which apertures are found on the base; and

FIG. 7 is a partial view of the article in the shape of a soccer ball showing a flat surface without a base.

### DETAILED DESCRIPTION OF THE INVENTION

The invention is described in detail below with reference to several embodiments and numerous examples. Such discussion is for purposes of illustration only. Modifications to particular examples within the spirit and scope of the present invention, set forth in the appended claims, will be readily apparent to one of skill in the art.

The present invention discloses a single unit, non-metal, crematory urn comprising a sports shaped article having a hollow center adapted for receiving and retaining cremated remains of at least one individual or pet, containing optionally a base attached to the article for support of the article, and an aperture, or opening, wherein the cremated remains are inserted. By single unit, it is meant that the entire unit is one piece. The remains are typically held in the sports shaped article, but may be placed in the base portion of the unit. The urn may be constructed of any substantially rigid thermoplastic resin or polymeric material suitable for making rigid, molded products. Preferably, the material is selected from the group of acrylonitrile butadiene styrene (ABS), polyacetal, polycarbonate, polyethylene (PE), polyethylene terephthalate (PET), polyethylene terephthalate ester (PETE), polyphenylene ether (PPE), polyvinyl chloride (PVC), polypropylene (PP), polyetherimide (PEI), and melamine formaldehyde, with polyethylene being most preferred based on cost and ease of use in manufacturing. The polymeric resins can be blended, and are chosen based on various factors such as cost, handling, toxicity, and environmental effects. Generally, the urn has at least one aperture found in the sports shaped article of the unit, but the aperture may also be placed on the base portion of the unit. For example, if a basketball shape is desired, the aperture for inserting the cremated remains may be on the bottom, back or top section of the ball. The aperture may have a removable closure, or be placed with a hinge-type mechanism for opening and closing of the closure element. The closure may also be a screw-type or rubber plug in type closure. Generally any closure which ensures a secure closing of the aperture may be used. The closure further may have a locking or sealing type mechanism for safe keeping of the remains. The aperture and closure are of a suitable size for ease in inserting the remains therein. An example of a suitable size is approximately 2.5×2.5 inches.

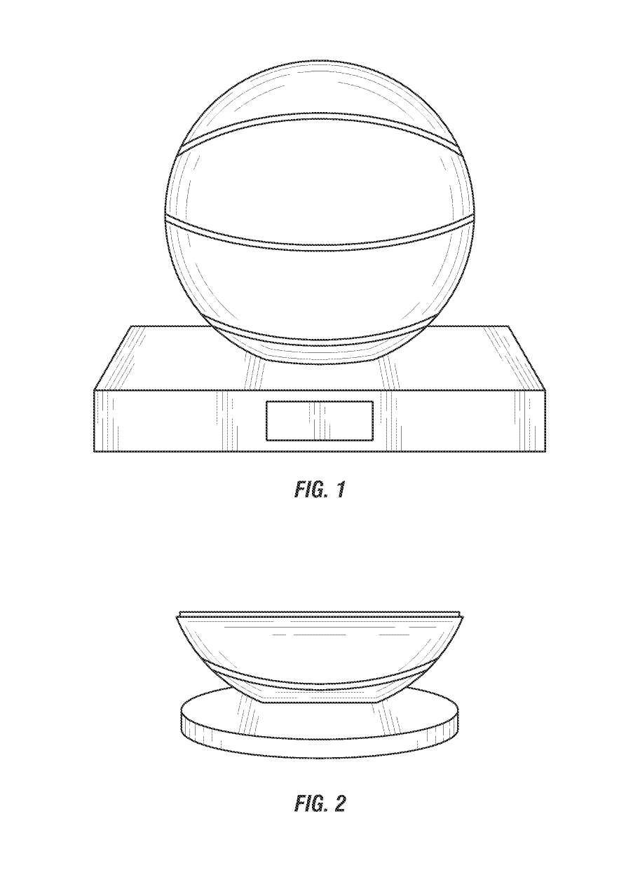

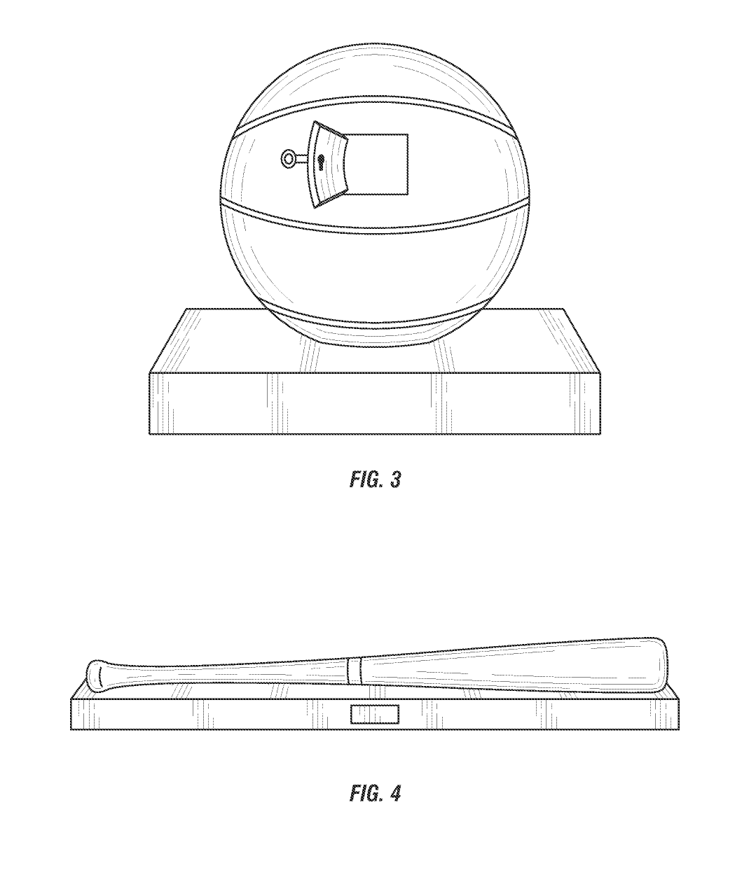

Various shapes of the unit may be utilized and the present examples are intended for illustrative and non-limiting purposes. For example, the single, non-metal unit may take the shape of a basketball, a baseball, a baseball glove, a baseball bat, a soccer ball, a hockey puck, a hockey stick, a football, a golf ball, a golf club, tennis racket and tennis ball, bowling ball and bowling pin, boxing glove, or a volleyball. Other athletic or sports shaped articles may be used provided there is a hollow center for potential storage of the cremated remains. Referring to the figures, FIG. 1 is a view of a crematory urn in the shape of a basketball on a base. FIG. 2 is a partial view of the basketball positioned on a narrower type of base. FIG. 3 is a view of the back of the basketball and base unit wherein the aperture is placed on the back of the unit, and is shown having a lockable, hinge-type closure. FIG. 4 is a view of a baseball bat on a representative base.

The urn or unit may also have at least one faceplate to identify the remains contained therein. It may also have at least one sports emblem indicating a favorite sports team of the deceased.

Optionally, the unit may have a clear or colored covering case over the sports shaped article resting on the base thereof. A case will allow for protection from the environment. Within the cover there may further be features to secure the sports shaped article and not allow it to move in the event of relocating the urn to another location, or a type of natural disaster (such as an earthquake, hurricane, or tornado) which may cause movement and possible breakage of the urn.

While the ashes or cremated remains of one individual human or pet may be housed in the unit, it is possible to have more than one housed within the same unit. The hollow center of the sports shaped article may have partitions for housing numerous remains of members. Alternatively, the base may have partitions for same. Each partition will have its respective aperture for inserting the cremated remains. Depending on the rigidity of the polymeric resin employed, if the hollow center is partitioned for holding cremated remains of more than one individual or pet, it may need to be adapted and supported internally with walls or the like, for the partition.

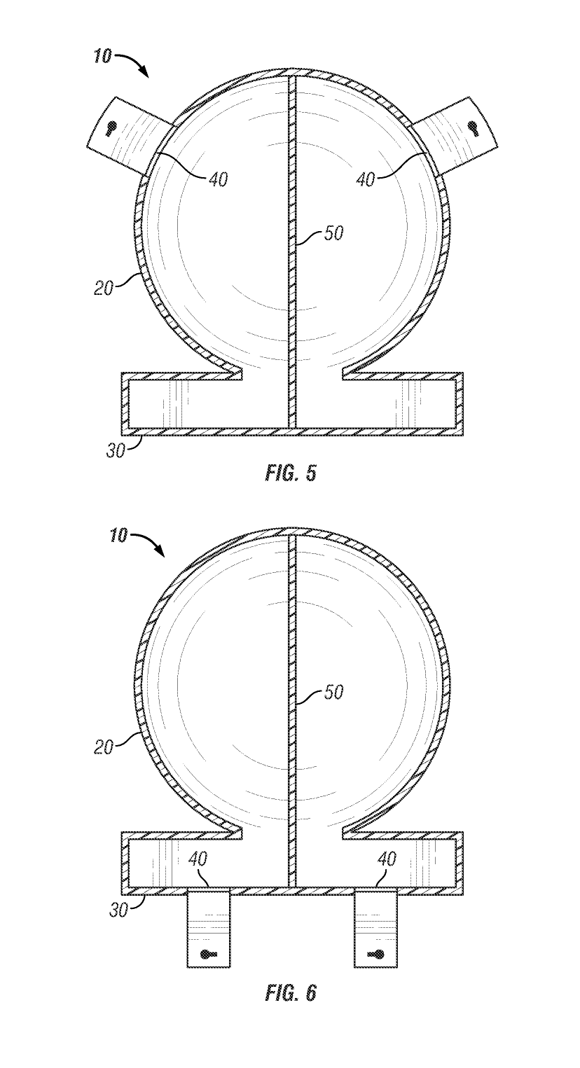

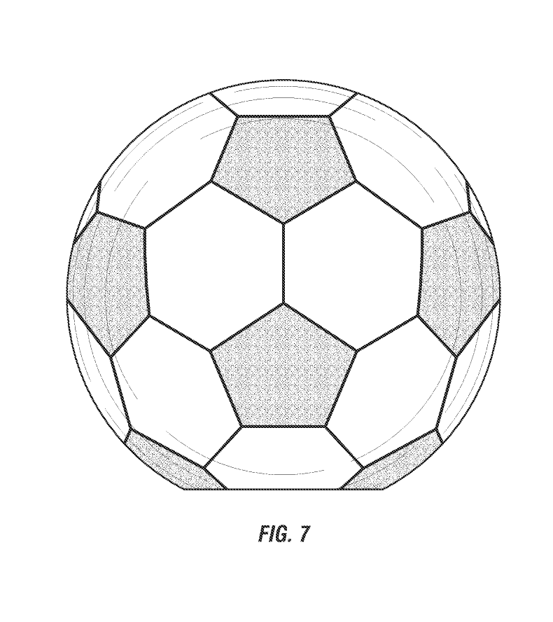

A partitioned unit is illustrated in FIG. 5. Unit 10, comprising sports shaped article 20, base 30 and aperture 40, is shown with section removed. Unit 10 has a partition 50 within the hollow center of article 20 and the base 30. An alternative embodiment is shown in FIG. 6, in which apertures 40 are present on the base 30.

The main advantage of the present invention, over that found presently in the art, is that a cremation container is provided which provides a loved one of a deceased an alternative, somewhat nontraditional yet nonetheless attractive, means of displaying the cremated remains of the deceased. A one unit system is simpler than a multiple unit system wherein parts can fall off and/or break. The polymeric material employed allows for longevity, and is more cost effective compared to metallic materials which are currently available. Additionally, a polymeric structure eliminates corrosion concerns often associated with metal urn containers.

While the discussion herein has focused on non-metal, one piece urn units, it is possible to create the unit from a metallic material which is resistant to the effects of natural elements such as rust and corrosion. For example, the one piece invention can be constructed from an effectively moldable metal such as aluminum, hastelloy, stainless steel, copper, and the like.

Another alternate embodiment of the present invention involves creation of a sports shaped urn without a base, wherein the sports shaped article has a relatively flat bottom portion to secure or lay to a flat surface, such as a chimney mantle, shelf, or the like. This embodiment is illustrated in FIG. 7.

Furthermore, while the present invention involves displaying the urn in public, it could also be used as a burial container. While metal may not be suitable for in-ground burial due to corrosion or rust concerns, a rigid, plastic urn, with or without a base, would be suitable for below ground burial thereof.

Thus, there is provided a single unit, non-metal crematory urn comprising a sports shaped article having a hollow center adapted for receiving and retaining cremated remains of at least one individual or pet and an aperture through which the cremated remains are inserted into the urn. Optionally, a base may attached to the article for support. The urn is generally constructed of a substantially rigid polymeric material, such as ABS, polyacetal, polycarbonate, polyethylene, PET, PETE, PPE, PVC, polypropylene, polyetherimide, and melamine formaldehyde. Preferably, the urn is constructed of polyethylene. The aperture may be located on the base of the unit or on the sports shaped article of the unit. The article may be formed in a sports shape including, but not limited to, a basketball, a baseball, a baseball glove, a baseball bat, a soccer ball, a hockey puck, a hockey stick, a football, a golf ball, a golf club, a volleyball, a boxing glove, a tennis racket, a tennis ball, a bowling ball, and a bowling pin. The urn may have at least one sports emblem indicating a sports team. A covering case may be provided over the sports shaped article, and may rest on the base. In some embodiments, the hollow center and/or optionally the base may have two partitioned areas and thus be suitable for housing cremated remains of at least two individual humans or pets. In these embodiments, each area may have its own respective aperture.

In other embodiments, a single unit crematory urn is provided, comprising: a hollow body formed of a substantially rigid, non-metal material defining an interior chamber and having an opening for access to the interior chamber; a base plate secured to the hollow body; and at least one partition positioned within the interior chamber so as to divide the interior chamber into at least two portions of substantially equal volume. The partition is formed of a substantially rigid material, and is secured to a side wall and a top wall of the hollow body. The partition(s) may be present in, or extend into, a base.

While the invention has been described in connection with preferred embodiments, modifications to those embodiments within the spirit and scope of the invention will be readily apparent to those of skill in the art. The invention is defined in the appended claims.

What is claimed is:

1. A single unit, non-metal crematory urn comprising:
a. a sports shaped article having a hollow center adapted for receiving and retaining cremated remains of at least one individual human or pet; and
b. an aperture wherein the cremated remains are inserted into the urn;
wherein the sports shaped article has a substantially planar surface suitable for securing to or laying flush against a flat surface.

2. The urn of claim 1, further comprising a covering case over the sports shaped article.

3. The urn of claim 1 wherein the urn is suitable for housing cremated remains of at least two individual humans or pets, hollow center having at least two partitioned areas therein, each area having its respective aperture.

4. The urn of claim 1, wherein the sports shaped article is in the shape of a helmet.

5. The urn of claim 1, wherein the sports shaped article has a base.
